(19) United States
(12) Patent Application Publication
(10) Pub. No.: US 2019/0283772 A1
(43) Pub. Date: Sep. 19, 2019

(54) DRIVING SUPPORT SYSTEM AND VEHICLE CONTROL METHOD

(71) Applicant: HONDA MOTOR CO., LTD., Tokyo (JP)

(72) Inventors: Kentaro ISHISAKA, Wako-shi (JP); Takemi TSUKADA, Wako-shi (JP)

(21) Appl. No.: 16/282,867

(22) Filed: Feb. 22, 2019

(30) Foreign Application Priority Data
Mar. 15, 2018 (JP) 2018-048353

(51) Int. Cl. B60W 50/08; G05D 1/00

(52) U.S. Cl. CPC B60W 50/087; G05D 1/0061; B60W 2600/00; B60W 2540/103; B60W 2720/106; G05D 1/0088

(57) ABSTRACT

A driving support system for a vehicle, the system comprises: a detection unit adapted to detect that an operation subject of acceleration/deceleration of the vehicle changes to a driver; and a correction unit adapted to correct a control amount in a decrease direction if the control amount is larger than a predetermined threshold when the driver's acceleration/deceleration operation of the vehicle is accepted in a predetermined range after detection by the detection unit, the control amount being based on the acceleration/deceleration operation.

### CROSS-REFERENCE TO RELATED APPLICATION(S)

This application claims priority to and the benefit of Japanese Patent Application No. 2018-048353 filed on Mar. 15, 2018, the entire disclosure of which is incorporated herein by reference.

### BACKGROUND OF THE INVENTION

### Field of the Invention

The present invention relates to a driving support system and a vehicle control method.

### Description of the Related Art

Conventionally, for a vehicle capable of automated driving, there is a timing for switching from manual driving to automated driving or vice versa. When switching from automated driving to manual driving, the vehicle gives some kind of notice to a driver and requests operation from the driver. Also, depending on the level of automated driving, the vehicle may support driver's operation (driving support).

In relation to driving support during cornering, Japanese Patent Laid-Open No. 2017-056880 describes brake control that reflects results of learning in preferences of the driver.

On the other hand, suppose a case in which driving is entrusted to automated driving for a certain period and then switched to manual driving performed by the driver. In such a case, since the driver has been away from operation for the certain period, it is conceivable that the accuracy of brake and accelerator operation has decreased. For example, compared with when manual driving is continued for a certain period of time, when the vehicle is driven by switching hurriedly from automated driving to manual driving, there will be a difference in an amount of brake depression and the like even in making the vehicle perform a same action.

### SUMMARY OF THE INVENTION

Thus, an object of the present invention is to enable an appropriate support to a driver in brake control just after the subject of control is switched from a system to the driver.

According to one embodiment of the present invention, there is provided a driving support system for a vehicle, the system including: a detection unit adapted to detect that an operation subject of acceleration/deceleration of the vehicle changes to a driver; and a correction unit adapted to correct a control amount in a decrease direction if the control amount is larger than a predetermined threshold when the driver's acceleration/deceleration operation of the vehicle is accepted in a predetermined range after detection by the detection unit, the control amount being based on the acceleration/deceleration operation.

According to another embodiment of the present invention, there is provided a control method for a vehicle, the method including: detecting that an operation subject of acceleration/deceleration of the vehicle changes to a driver; and correcting a control amount in a decrease direction if the control amount is larger than a predetermined threshold when the driver's acceleration/deceleration operation of the vehicle is accepted in a predetermined range after detection in the detecting, the control amount being based on the acceleration/deceleration operation.

The present invention enables an appropriate support to the driver in brake control just after the subject of control is switched from the system to the driver.

Further features of the present invention will become apparent from the following description of exemplary embodiments (with reference to the attached drawings).

### BRIEF DESCRIPTION OF THE DRAWINGS

FIG. 1 is a block diagram of a vehicle control system according to an embodiment of the present invention;

FIG. 2 is a diagram for explaining a problem for the present invention;

FIG. 3 is a diagram for explaining brake control according to the present embodiment;

FIG. 4 is a flowchart showing a flow of processing according to the present embodiment;

FIG. 5 is a flowchart showing a process of brake control support according to the present embodiment;

FIG. 6 is a diagram for explaining brake control according to the present embodiment; and

FIG. 7 is a diagram for explaining brake control according to the present embodiment.

### DESCRIPTION OF THE EMBODIMENTS

An embodiment of the present invention will be described below with reference to the accompanying drawings. Note that the configuration and the like shown below are exemplary and are not restrictive.

### First Embodiment

### [Configuration]

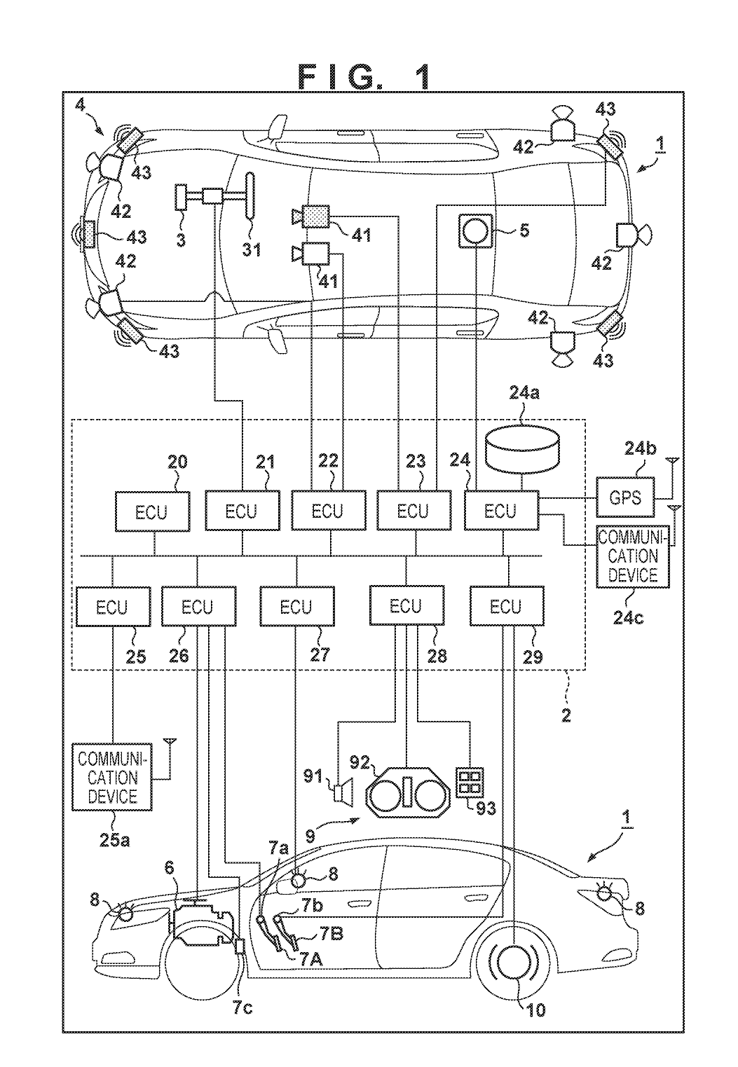

FIG. 1 is a block diagram of a vehicle controller according to an embodiment of the present invention, where the controller controls a vehicle 1. In FIG. 1, an outline of the vehicle 1 is shown in plan view and side view. As an example, the vehicle 1 is a four-wheel passenger car of a sedan type.

The controller in FIG. 1 includes a control unit 2. The control unit 2 includes plural ECUs 20 to 29 connected via an in-vehicle network in such a way as to be able to communicate. Each of the ECUs includes a processor typified by a CPU, a storage device such as a semiconductor memory, and an interface with external devices. The storage device stores programs executed by the processor, data used by the processor in processing, and the like. Each ECU may include plural processors, storage devices, and interfaces.

Functions undertaken by the ECUs 20 to 29 will be described below. Note that regarding the number of ECUs and the functions undertaken by the ECUs, the vehicle 1 can be designed as appropriate and the ECUs may be more refined or integrated than in the present embodiment.

The ECU 20 performs control concerning automated driving of the vehicle 1. In the automated driving, at least one of steering and acceleration/deceleration of the vehicle 1 is automatically controlled. In a control example described later, both steering and acceleration/deceleration are automatically controlled.

The ECU 21 controls an electric power steering device 3. The electric power steering device 3 includes a mechanism for steering front wheels according to driver's driving operation (steering operation) with respect to a steering wheel 31. The electric power steering device 3 also includes a motor, a sensor, and the like, where the motor develops a driving force used to assist the steering operation or automatically steer the front wheels and the sensor detects a steering angle. When operational status of the vehicle 1 is automated driving, the ECU 21 automatically controls the electric power steering device 3 in response to instructions from the ECU 20 and controls a direction of travel of the vehicle 1.

The ECUs 22 and 23 control detection units 41 to 43 adapted to detect ambient conditions of the vehicle and performs information processing about detection results. The detection units 41 are cameras (hereinafter sometimes referred to as the cameras 41) adapted to photograph something ahead of the vehicle 1, and mounted on an inner side of a front window forward of a roof of the vehicle 1 in the case of the present embodiment. By analyzing images taken by the cameras 41, it is possible to extract a contour of a target or extract a section line (e.g., while line) of traffic lanes on a road.

The detection units 42 are light detection and ranging (LIDAR) devices (hereinafter sometimes referred to as lidars 42) and detect a target around the vehicle 1 and measure a distance to the target. According to the present embodiment, five lidars 42 are provided: one each at front corners of the vehicle 1, one at rear center, and one each on rear flanks. The detection units 43 are millimeter-wave radars (hereinafter sometimes referred to as radars 43) and detect a target around the vehicle 1 and measure a distance to the target. According to the present embodiment, five radars 43 are provided: one at front center of the vehicle 1, one each at front corners, and one each at rear corners.

The ECU 22 controls one of the cameras 41 as well as the lidars 42 and performs information processing about detection results. The ECU 23 controls another of the cameras 41 as well as the radars 43 and performs information processing about detection results. The installation of two sets of devices adapted to detect ambient conditions of the vehicle enables improving reliability of detection results and the installation of different types of detection units—namely, cameras, lidars, and radars—enables multilaterally analyzing ambient surroundings of the vehicle.

The ECU 24 controls a gyro sensor 5, GPS sensor 24b, and communication device 24c, and performs information processing about detection results or communication results. The gyro sensor 5 detects rotary motion of the vehicle 1. Detection results produced by the gyro sensor 5, wheel speed, and the like enable judging a course of the vehicle 1. The GPS sensor 24b detects a current position of the vehicle 1. The communication device 24c conducts radio communications with a server that provides map information and traffic information, and acquires this information. The ECU 24, which can access a map information database 24a built in a storage device, searches for a route from the present location to a destination. Also, the database 24a keeps information and the like detected by various sensors.

The ECU 25 includes a communication device 25a for vehicle-to-vehicle communications. The communication device 25a conducts radio communications with other vehicles in the surroundings and exchanges information with the other vehicles.

The ECU 26 controls a power plant 6. The power plant 6 is a mechanism adapted to output a driving force to rotate driving wheels of the vehicle 1, and includes, for example, an engine and a transmission. The ECU 26 controls engine output in response to the driver's driving operation (accelerator operation or accelerating operation) detected, for example, by an operation detection sensor 7a provided on an accelerator pedal 7A or changes a gear range of the transmission based on information such as vehicle speed detected by a vehicle speed sensor 7c. When operational status of the vehicle 1 is automated driving, the ECU 26 automatically controls the power plant 6 in response to instructions from the ECU 20, and controls acceleration and deceleration of the vehicle 1.

The ECU 27 controls lighting equipment (headlights, tail lights, etc.) including direction indicators 8. In the example of FIG. 1, direction indicators 8 are provided in front part, sideview mirrors, and rear part of the vehicle 1.

The ECU 28 controls input/output devices 9. The input/output devices 9 output information to the driver and accepts input of information from the driver. A voice output device 91 conveys information to the driver by voice. A display device 92 conveys information to the driver by displaying images. The display device 92 is placed, for example, in front of a driver's seat, making up an instrument panel or the like. Note that although voice and display are cited as examples here, information may be conveyed by vibration or light. Also, information may be conveyed by a combination of two or more of voice, display, vibration, and light. Furthermore, the combination or the mode for conveying the information may be varied depending on the level (e.g., urgency) of information to be conveyed. An input device 93 is a switch group used to give commands to the vehicle 1 by being placed in such a position as to be able to be operated by the driver, but may include a voice input device.

The ECU 29 controls a braking device 10 and parking brake (not shown). The braking device 10 is, for example, a disc braking device, is provided on each wheel of the vehicle 1, and decelerates or stops the vehicle 1 by applying resistance to rotation of the wheel. The ECU 29 controls operation of the braking device 10 in response to the driver's driving operation (brake operation) detected, for example, by an operation detection sensor 7b provided on a brake pedal 7B. When the operational status of the vehicle 1 is automated driving, the ECU 29 automatically controls the braking device 10 in response to instructions from the ECU 20, and controls deceleration and stoppage of the vehicle 1. The braking device 10 and parking brake can also be actuated to maintain a stopped state of the vehicle 1. Also, when the transmission of the power plant 6 is equipped with a parking lock mechanism, the mechanism can be actuated to maintain a stopped state of the vehicle 1.

[Further Explanation of Problem]

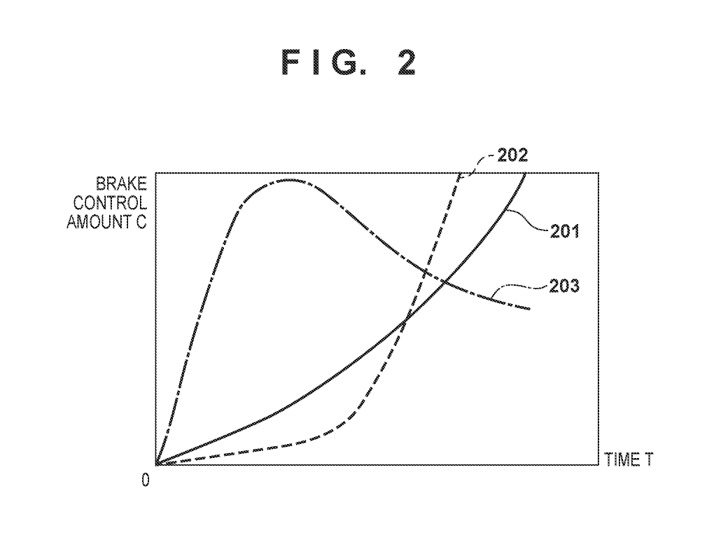

FIG. 2 is a diagram for explaining a problem assumed in the present invention. In FIG. 2, the ordinate represents a control amount C of the brake manipulated by the driver of the vehicle while the abscissa represents passage of time. Here, a time T of 0 corresponds to braking start timing at a certain time point.

In FIG. 2, line 201 shows how the brake is operated at a certain time point (time: 0), followed by gradual increases in the control amount of the brake. It is assumed here that the brake is operated smoothly with appropriate strength, increasing the control amount of the brake. Line 202 shows how the brake is operated with a small control amount at a certain time point (time: 0), followed by subsequent sudden increases in the control amount of the brake. This occurs when brake control is started late or when an initial amount of depression (control amount) is insufficient. Line 203 shows how the brake is operated with an excessive control amount (abrupt braking) at a certain time point (time: 0), followed by subsequent decreases in the control amount of the brake. This occurs when the initial amount of depression (control amount) is excessive.

For example, when switching is done from automated driving to manual driving, because the driver has been away from operation (brake operation, in this case) for a certain period, accuracy of operation decreases. Consequently, just after switching from automated driving to manual driving, operation indicated by line 202 or line 203 above may occur in brake operation. This affects ride comfort and the like of passengers of the vehicle.

Thus, considering the above circumstances, the present invention provides a driving support system to support brake control when the subject of vehicle control is switched to the driver such as just after switching from automated driving to manual driving.

[Brake Control Support]

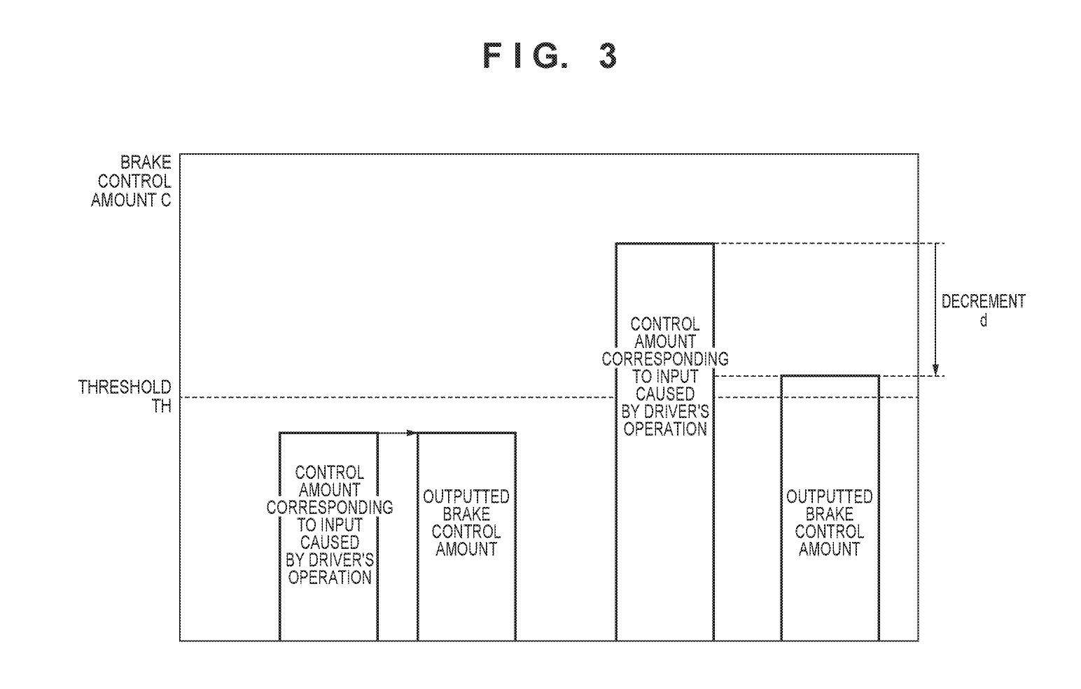

FIG. 3 is a diagram for explaining a control example in brake control support according to the present embodiment. In FIG. 3, the ordinate represents the brake control amount C. In FIG. 3, a threshold TH is set, and it is assumed that the driver operates the brake with certain timing.

As shown on the left side of FIG. 3, suppose the driver operates the brake and a resulting brake control amount (amount of deceleration) is equal to or smaller than the threshold TH. In this case, a value equivalent to a control amount corresponding to the input is outputted as the brake control amount.

On the other hand, as shown on the right side of FIG. 3, suppose the driver operates the brake and a resulting brake control amount (amount of deceleration) is larger than the threshold TH. In this case, the control amount corresponding to the input is decreased by a decrement d, and a value resulting from the decrease is treated as the brake control amount. The decrement d will be described later.

[Processing Flow]

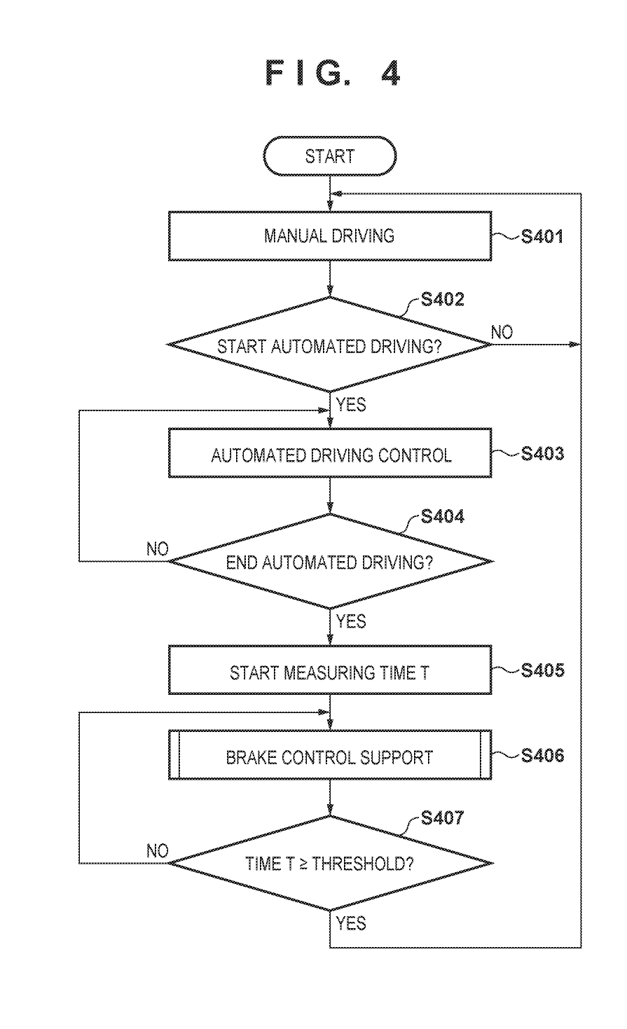

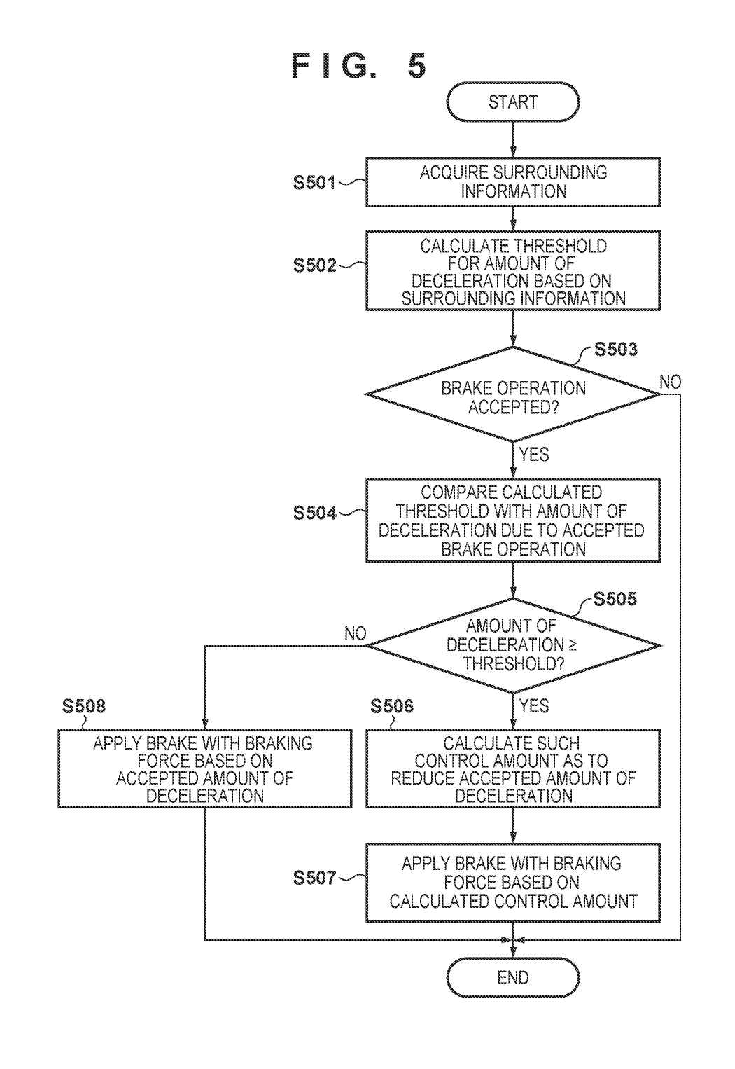

A flow of processing according to the present embodiment will be described below with reference to FIGS. 4 and 5. It is assumed that the vehicle 1 according to the present embodiment switches from automated driving to manual driving or vice versa in response to user commands. The operation subject of automated driving will be described here simply as being the vehicle 1 for simplicity of explanation. It is assumed that the present processing flow starts when the vehicle 1 is started up by the driver.

In S401, the vehicle 1 starts running based on a command from the driver. At this point, it is assumed that the vehicle 1 is manually driven by the driver.

In S402, the vehicle 1 determines whether a command to start automated driving has been accepted from the driver. The automated driving may be started, for example, in response to a press of an automated-driving start button or a voice command by the driver. When a command to start automated driving is given (YES in S402), the vehicle 1 goes to S403, but when a command start automated driving is not given (NO in S402), the vehicle 1 returns to S401 and continues manual driving.

In S403, the vehicle 1 performs automated driving control. Specifics of the automated driving control here is not particularly limited, and the automated driving control is performed according to ambient surroundings and conditions of the driver.

In S404, the vehicle 1 determines whether a command to end the automated driving has been accepted. The end command here may be given not only based on a command from the driver, but also under the control of the system according to information on ambient surroundings and the like. When a command to end automated driving is given (YES in S404), the vehicle 1 goes to S405, but when a command to end automated driving is not given (NO in S404), the vehicle 1 goes to S403 and continues automated driving.

In S405, upon ending automated driving, the vehicle 1 starts measuring time T. It is assumed that time is measured here by a timekeeping unit (not shown).

In S406, the vehicle 1 provides brake control support according to the present embodiment. This process will be described later with reference to FIG. 5.

In S407, the vehicle 1 determines whether the time T being measured has exceeded a predetermined threshold. It is assumed that the predetermined threshold has been established beforehand and held in a storage unit (not shown). When the time T reaches or exceeds the threshold (YES in S407), the vehicle 1 returns to S401 and does manual driving. When the time T is less than the threshold (NO in S407), the vehicle 1 returns to S406 and continues brake control support.

It is assumed that the present processing flow ends, for example, just when running motion of the vehicle 1 is ended.

[Brake Control Support]

The process of brake control support according to the present embodiment will be described below with reference to FIG. 5. FIG. 5 corresponds to the step of S406 in FIG. 4. Note that at this point, the vehicle 1 has just switched from automated driving to manual driving.

In S501, the vehicle 1 acquires surrounding information using various sensors. The surrounding information acquired here may include information about road surface conditions, the presence or absence of other vehicles, or distances to other vehicles. The form of the surrounding information is not particularly limited, and may be image data or voice data. Note that the present embodiment, in which brake-related control is performed, may be configured to acquire surrounding information ahead of the vehicle 1 on a priority basis.

In S502, based on the surrounding information acquired in S501, the vehicle 1 calculates a threshold for the control amount (amount of deceleration) produced by the driver's brake operation. For example, the threshold for the amount of deceleration during braking may be calculated based on an inter-vehicle distance to another vehicle running ahead. Alternatively, depending on the presence or absence of a pedestrian crossing located ahead, the threshold for the amount of deceleration may be calculated from a distance to the pedestrian crossing. Alternatively, if there is a curve in the direction of travel, the threshold for the amount of deceleration may be calculated from a distance to the curve or curvature (radius) of the curve. Also, the threshold may be kept constant unless a predetermined condition occurs in the surroundings. Note that although surrounding information has been cited here, this is not restrictive, and the threshold for the amount of deceleration may be calculated using map information or a condition (running speed or weight) of the self-vehicle. That is, the threshold for the amount of deceleration caused by the brake is calculated by taking the ambient surroundings into consideration such that a braking force of the brake will not be unnecessarily great (strong). Note that the threshold is changed at any time according to the surrounding information.

In S503, the vehicle 1 determines whether a brake operation has been accepted from the driver. If a brake operation has been accepted (YES in S503), the vehicle 1 goes to S504, but if no brake operation has been accepted (NO in S503), the vehicle 1 ends the present processing flow.

In S504, the vehicle 1 compares the threshold for the amount of deceleration calculated in S502 with the amount of deceleration due to the brake operation accepted in S503. The amount of deceleration due to the brake operation is identified, for example, by depression of the brake pedal. It is assumed that correspondence between the amounts of depression of the brake pedal and amounts of deceleration due to brake operation is held as predefined data.

In S505, based on a result of the comparison in S504, the vehicle 1 determines whether the amount of deceleration (control amount) due to the driver's brake operation is equal to or greater than the threshold calculated in S502. When the amount of deceleration is equal to or greater than the threshold (YES in S505), the vehicle 1 goes to S506, but when the amount of deceleration is smaller than the threshold (NO in S505), the vehicle 1 goes to S508.

In S506, the vehicle 1 calculates such a control amount as to reduce the amount of deceleration due to the driver's brake operation. Regarding the reduction here, for example, the amount of deceleration may be set equal to the threshold calculated in S502 or the amount of reduction may be determined according to a difference between the amount of deceleration due to the driver's brake operation and the threshold calculated in S502. The amount of deceleration according to the present embodiment will be described below.

In S507, the vehicle 1 controls the brake based on the control amount calculated in S506. Then, the vehicle 1 ends the present processing flow and returns to the process of FIG. 4.

In S508, the vehicle 1 controls the brake based on the control amount due to the driver's brake operation accepted in S503. Then, the vehicle 1 ends the present processing flow and returns to the process of FIG. 4.

[About Decrement]

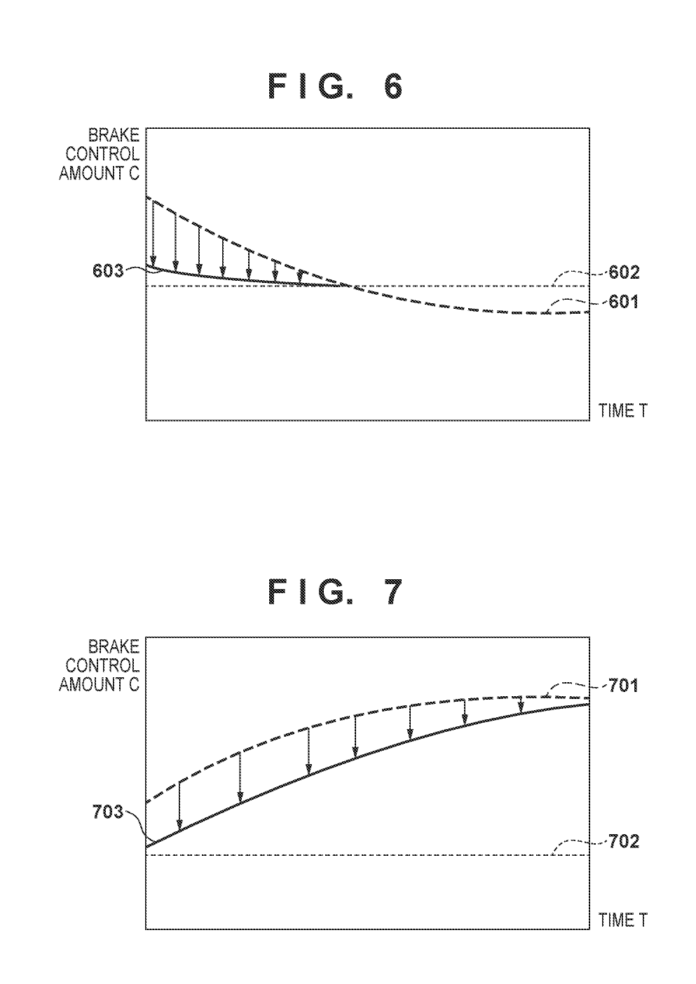

FIGS. 6 and 7 are diagrams for explaining brake control based on the above-mentioned processing flows according to the present embodiment. Note that in the examples shown in FIGS. 6 and 7, the threshold TH is assumed to be constant for simplicity of explanation. However, the threshold TH can be varied at any time based on surrounding information and the like as described above.

In FIG. 6, the ordinate represents the brake control amount C while the abscissa represents passage of time. Line 601 shows variation in the control amount (input) produced by the driver's brake operation. Line 602 shows the threshold TH related to brake control support. Line 603 shows control amounts outputted in response to the input caused by the driver's brake operation.

As shown in FIG. 6, the brake control support according to the present invention is provided until input falls below the threshold TH. Subsequently, when the input falls below the threshold TH, a value corresponding to the input is treated as an output. Here, as shown in FIG. 6, the decrement d changes according to a difference between the input and threshold value. For example, control may be performed such that the larger the differences between the input and threshold, the larger the decrement d. Alternatively, the decrement d may be varied when the input continues to exceed the threshold TH for a certain period of time.

Similarly, in FIG. 7, the ordinate represents the brake control amount C while the abscissa represents passage of time. Line 701 shows variation in the control amount (input) produced by the driver's brake operation. Line 702 shows the threshold TH related to brake control support. Line 703 shows control amounts outputted in response to the input caused by the driver's brake operation.

In FIG. 7, since initial input (control amount) of the driver's brake operation exceeds the threshold TH, brake control support is provided. Furthermore, the control amount (input) produced by the driver's brake operation increases subsequently. In this case, by regarding that the driver requests further braking (deceleration), the system performs control such that the control amount will approach the driver's input. That is, the system performs control such that the decrement d will be decreased gradually. In so doing, by performing control such that line 703 showing output of the brake control amount will become smoother, it is possible to inhibit sudden deceleration (abrupt braking).

Thus, with the present embodiment, when the operation subject of the vehicle changes such as upon switching from automated driving to manual driving, brake control can be supported by taking into consideration the operating accuracy of the driver involved in manual driving.

### Other Embodiments

Note that when the difference between the threshold TH and input of the driver's brake operation is equal to or greater than a predetermined value, the system may avoid providing brake control support even immediately after switching to the manual driving according to the present embodiment by determining that it is an emergency.

Also, when a distance between the self-vehicle and a target (e.g., another vehicle or a structure) located ahead is smaller (closer) than a predetermined value, when speed of the self-vehicle relative to the vehicle located ahead is greater than a predetermined value, or in other similar cases, the threshold TH may be set to a high value by determining that it is an emergency. In this case again, even if the driver operates the brake forcefully, since the threshold TH is set high, no decrease correction is made or the decrement d is reduced. Consequently, the input produced by the driver's brake operation is outputted as it is or almost as it is. Also, the threshold TH and decrement d may be determined depending on the presence/absence or running state of a vehicle behind.

Also, in the flow of processing described above, although brake control support is provided for a certain period of time just after automated driving is ended, this is not restrictive. For example, the system may be configured to avoid providing brake control support when a duration of automated driving is equal to or shorter than a predetermined period of time. Conceivably, this includes a case where it is regarded that the accuracy of brake operation is not affected because the period for which the driver has been away from operation is short.

Even during a certain period of time just after automated driving is ended, if brake control support is provided once for user's brake operation, the system may avoid providing brake control support for subsequent brake operation.

Also, the system may be configured to avoid providing brake control support even during a certain period of time just after automated driving is ended if a predetermined distance has been traveled. Conceivably, this includes a case where the driver operates something (e.g., accelerator) other than the brake after the end of automated driving and it is regarded that the accuracy of the operation is not affected.

Although the process described above is an example in which brake control support is provided when switching is done from automated driving to manual driving, this is not restrictive. For example, by establishing plural levels (modes) of automated driving, the system may be configured to provide brake control support during transition to a level at which the driver operates the brake.

Also, there are cases in which a command to end automated driving is given through brake operation. In such a configuration, the system may be configured to avoid providing brake control support according to the present embodiment if the command to end automated driving accepted in S404 of FIG. 4 has been given through brake operation. That is, when the driver performs such brake operation, the system performs such control as to omit brake control support by regarding that there is no problem with the accuracy of driver's brake operation. Note that the method for ending automated driving is not limited to the one described above, and the necessity of brake control support may be determined according to other ending conditions.

Also, based on conditions for ending automated driving, the specifics of brake control support may be changed. For example, as a condition for ending automated driving the automated driving may be ended on schedule upon arrival at the area around a predetermined destination. On the other hand, automated driving may be terminated forcefully (unexpected termination) due to an internal system failure, a functional limit of the system, an external factor (road conditions or weather), or the like taking place during the automated driving. Brake control support is changed according to circumstances of such a termination. Specifically, in the case of a scheduled end, the brake control support may be enabled or effects of the brake control support may be increased. On the other hand, in the case of an unexpected termination the brake control support may be disabled or the threshold TH may be set higher. Also, the system may be configured to set different values of the threshold TH according to the type of unexpected termination. This makes it possible to configure the system, for example, to give priority to the driver's operation as an emergency measure in case of an unexpected termination.

Also, the above embodiment has been described by citing control during deceleration operation (brake operation). However, this is not restrictive, and the system may be configured to perform similar control during acceleration operation. Furthermore, the system may be configured to perform control over both brake operation and acceleration operation.

### Summary of Embodiment

1. The driving support system according to the above embodiment is a driving support system for a vehicle (e.g., 1), the system including: a detection unit (e.g., 2) adapted to detect that an operation subject of acceleration/deceleration of the vehicle changes to a driver; and a correction unit (e.g., 29) adapted to correct a control amount in a decrease direction if the control amount is larger than a predetermined threshold when the driver's acceleration/deceleration operation of the vehicle is accepted in a predetermined range after detection by the detection unit, the control amount being based on the acceleration/deceleration operation.

When the subject of control is switched from the system to the driver, this embodiment enables appropriate support for the driver in brake control just after the switching.

2. The driving support system according to the above embodiment further includes: an acquisition unit (e.g., 41 or 43) adapted to acquire surrounding information on the vehicle; and a determination unit (e.g., 29) adapted to determine the predetermined threshold based on the surrounding information acquired by the acquisition unit.

This embodiment enables determining a threshold for appropriate brake operation according to ambient surroundings of the vehicle.

3. In the driving support system according to the above embodiment; the predetermined range is a time interval from when the detection is made by the detection unit until a predetermined time elapses or a range from a position where the detection is made by the detection unit to a place reached by the vehicle after traveling a predetermined distance.

This embodiment enables curbing excessive decreases in an amount of operation on the part of the system and providing brake operation support to the driver in an appropriate range.

4. In the driving support system according to the above embodiment, when the control amount based on the driver's acceleration/deceleration operation of the vehicle is increasing, the correction unit decreases a decrement of the control amount.

This embodiment enables appropriate brake driving support according to changes in the driver's brake operation.

5. In the driving support system according to the above embodiment, when a distance from the vehicle to a target located ahead is smaller than a predetermined value or when speed of the vehicle relative to a vehicle located ahead is greater than a predetermined value, the correction unit makes no correction to the control amount of the acceleration/deceleration of the vehicle.

This embodiment enables appropriately switching between whether or not to provide brake control support, according to surrounding circumstances.

6. In the driving support system according to the above embodiment, the driver's acceleration/deceleration operation of the vehicle is brake operation.

This embodiment enables providing appropriate driving support in terms of an amount of brake operation.

7. In the driving support system according to the above embodiment, the vehicle is able to accept a command to switch the operation subject to the driver, by a first method using brake operation and by a second method different from the first method; and the correction unit makes no correction to the control amount of the acceleration/deceleration of the vehicle when the detection unit detects a command accepted by the first method.

This embodiment enables providing appropriate driving support in terms of the amount of brake operation, according to the method for specifying the brake operation of the vehicle.

8. In the driving support system according to the above embodiment, when switching is done from automated driving to manual driving, the detection unit detects a change in the operation subject of acceleration/deceleration of the vehicle to the driver.

This embodiment enables providing operation support to the driver in terms of appropriate brake operation when switching is done from automated driving to manual driving.

9. A control method according to the above embodiment is a control method for a vehicle (e.g., 1), the method including: detecting that an operation subject of acceleration/deceleration of the vehicle changes to a driver; and correcting a control amount in a decrease direction if the control amount is larger than a predetermined threshold when the driver's acceleration/deceleration operation of the vehicle is accepted in a predetermined range after detection in the detecting, the control amount being based on the acceleration/deceleration operation.

When the subject of control is switched from the system to the driver, this embodiment enables appropriate support for the driver in brake control just after the switching.

What is claimed is:

1. A driving support system for a vehicle, the system comprising:
a detection unit adapted to detect that an operation subject of acceleration/deceleration of the vehicle changes to a driver; and
a correction unit adapted to correct a control amount in a decrease direction if the control amount is larger than a predetermined threshold when the driver's acceleration/deceleration operation of the vehicle is accepted in a predetermined range after detection by the detection unit, the control amount being based on the acceleration/deceleration operation.

2. The driving support system according to claim 1, further comprising:
an acquisition unit adapted to acquire surrounding information on the vehicle; and
a determination unit adapted to determine the predetermined threshold based on the surrounding information acquired by the acquisition unit.

3. The driving support system according to claim 1, wherein the predetermined range is a time interval from when the detection is made by the detection unit until a predetermined time elapses or a range from a position where the detection is made by the detection unit to a place reached by the vehicle after traveling a predetermined distance.

4. The driving support system according to claim 1, wherein when the control amount based on the driver's acceleration/deceleration operation of the vehicle is increasing, the correction unit decreases a decrement of the control amount.

5. The driving support system according to claim 1, wherein when a distance from the vehicle to a target located ahead is smaller than a predetermined value or when speed of the vehicle relative to a vehicle located ahead is greater than a predetermined value, the correction unit makes no correction to the control amount of the acceleration/deceleration of the vehicle.

6. The driving support system according to claim 1, wherein the driver's acceleration/deceleration operation of the vehicle is brake operation.

7. The driving support system according to claim 6, wherein:
the vehicle is able to accept a command to switch the operation subject to the driver, by a first method using brake operation and by a second method different from the first method; and
the correction unit makes no correction to the control amount of the acceleration/deceleration of the vehicle when the detection unit detects a command accepted by the first method.

8. The driving support system according to claim 1, wherein when switching is done from automated driving to manual driving, the detection unit detects a change in the operation subject of acceleration/deceleration of the vehicle to the driver.

9. A control method for a vehicle, the method comprising:
detecting that an operation subject of acceleration/deceleration of the vehicle changes to a driver; and
correcting a control amount in a decrease direction if the control amount is larger than a predetermined threshold when the driver's acceleration/deceleration operation of the vehicle is accepted in a predetermined range after detection in the detecting, the control amount being based on the acceleration/deceleration operation.
